(19) United States
(12) Patent Application Publication
(10) Pub. No.: US 2014/0046958 A1
(43) Pub. Date: Feb. 13, 2014

(54) CONTENT MANAGEMENT SYSTEM

(71) Applicant: Todd Tucker, Tulsa, OK (US)

(72) Inventor: Todd Tucker, Tulsa, OK (US)

(21) Appl. No.: 13/939,145

(22) Filed: Jul. 10, 2013

Related U.S. Application Data
(60) Provisional application No. 61/669,760, filed on Jul. 10, 2012.

(51) Int. Cl. G06F 17/30

(52) U.S. Cl. CPC G06F 17/30861
USPC 707/748

(57) ABSTRACT

Systems and methods for content management are provided herein. In some instances, a method may include receiving content comprising end user opinions regarding third parties, calculating a score for each of the third parties from the end user opinions, the score representing whether the end user opinions are positive or negative, publishing a profile for a user to a first website if the score of the one or more third parties is determined to be positive, and publishing a profile for a user to a second website if the score of the one or more third parties is determined to be negative.

### CROSS-REFERENCE TO RELATED APPLICATION

This non-provisional US patent application claims the priority benefit of U.S. provisional application Ser. No. 61/669,760, entitled “CONTENT MANAGEMENT SYSTEM,” which is hereby incorporated by reference herein in its entirety including all references cited therein.

### FIELD OF THE PRESENT TECHNOLOGY

The present technology relates generally to online content management systems, and more specifically, but not by way of limitation, to content management systems and methods that mediate the exchange of data between two or more websites that host oppositely themed content relative to one another.

### BACKGROUND

Content management systems that enable websites, which are published to the Internet, are well known. Content management systems are often used to manage (e.g., establish, edit, monitor, etc.) the content on a website. Exemplary types of content may include textual data, video files, audio files, multimedia files, animations, and/or image files—just to name a few. Furthermore, some content management systems allow for the same content (or variations of the same content) to be published to multiple websites.

### SUMMARY

According to some embodiments, the present technology may be directed to a method for managing content between two or more web servers providing websites that comprise oppositely themed content relative to one another, the method comprising: (a) receiving content comprising end user opinions regarding third parties; (b) calculating a score for each of the third parties from the end user opinions, the score representing whether the end user opinions are positive or negative; (c) publishing a profile for a user to a first website if the score of the one or more third parties is determined to be positive; and (d) publishing a profile for a user to a second website if the score of the one or more third parties is determined to be negative.

According to some embodiments, the present technology may be directed to a content management system, comprising: (a) a memory for storing executable instructions; and (b) a processor for executing the executable instructions to perform operations comprising: (i) receiving content comprising end user opinions regarding third parties; (ii) calculating a score for each of the third parties from the end user opinions, the score representing whether the end user opinions are positive or negative; (iii) publishing a profile for a user to a first website if the score of the one or more third parties is determined to be positive; and (iv) publishing a profile for a user to a second website if the score of the one or more third parties is determined to be negative.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is an exemplary architecture for practicing aspects of the present technology.

FIG. 2 is a block diagram of an exemplary computing system for implementing embodiments of the present technology.

FIG. 3 is a flowchart of an exemplary method for managing content between two or more web servers providing websites that comprise oppositely themed content relative to one another.

FIG. 4 is a flowchart of an exemplary sub-method for continuous monitoring of scores for third parties.

### DETAILED DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

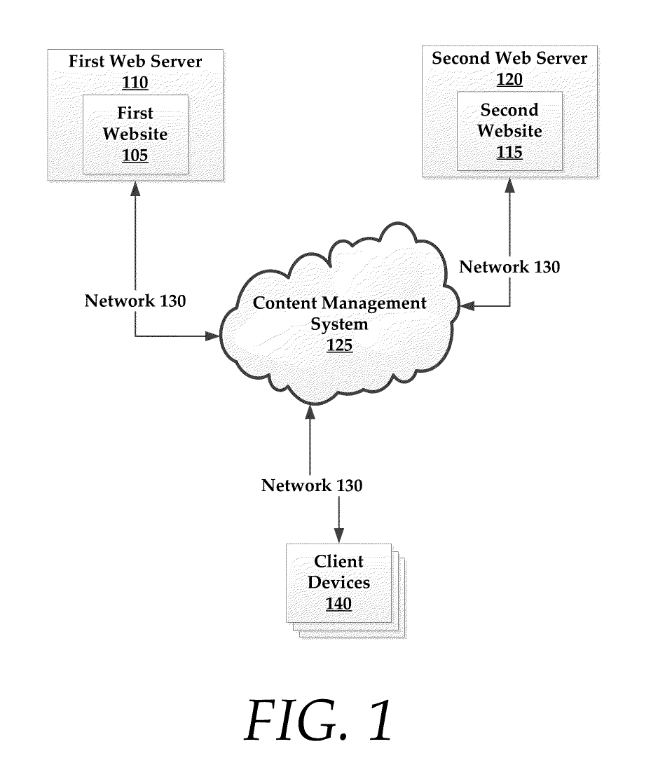

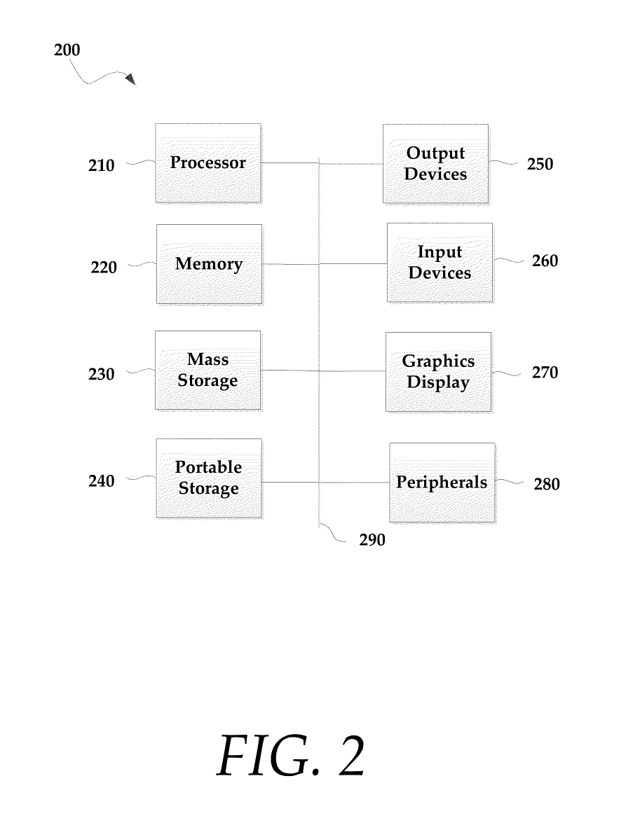

Referring now to the collective drawings FIGS. 1-2, an exemplary architecture 100 is shown as comprising a first website 105 hosted on a first web server 110 and a second website 115 hosted on a second web server 120. Generally speaking, the architecture 100 may also comprise a content management system, hereinafter “system 125” that is communicatively coupled with the first web server 110 and the second web server 120 via a network 130. The system 125 may be utilized to broker or mediate content between the first and second websites 110 and 120 as will be described in greater detail infra.

It will be understood that the network 130 may comprise any public or private communications network that would be known to one of ordinary skill in the art with the present disclosure before them, such as the Internet. In some instances the network 130 may comprise an Intranet network such as a L.A.N. (Local Area Network) or W.A.N. (Wide Area Network), a V.P.N. (Virtual Private Network)—just to name a few.

End users of the first and second websites 105 and 115 may interact with the first and second web servers 110 and 120 via client devices 140. Administrators of a system 125 may interact with the system 125 via client devices 140. Generally speaking, the client devices 140 may comprise any type of end user computing system such as a desktop, a laptop, or a mobile computing device such as cellular telephone. Exemplary details regarding an end user computing system are provided with reference to FIG. 2.

In some embodiments, the system 125 may be configured as a cloud-based computing environment. In general, a cloud-based computing environment is a resource that typically combines the computational power of a large grouping of processors (such as within a plurality of physical/virtual web servers) and/or that combines the storage capacity of a large grouping of computer memories or storage devices. For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The system 125 may be described as computing system that is specifically adapted for the particular purposes of managing content between two or more web servers that host websites that comprise oppositely themed content relative to one another. For example, a first website may comprise a positively themed social media platform that allows end users to post content relative to third parties (e.g., other people, businesses, products, services, and so forth). The second website may comprise a negatively themed social media platform that allows end users to post content relative to third parties.

Initially, end users may establish a profile for a third party that includes any descriptive information known about the third party such as name, location, place of business, and so forth. After establishing the profile, end users may then post reviews relative to the third party.

In some instances, end users may rank third parties to communicate their opinion about said third parties. For example, an end user may input a post about a third party along with identifying information for the third party determined from the profile established for the third party. Additionally, the end user may indicate a level of positivity or negativity relative to the third party. The higher the value input by the end user, the more positively ranked the third party is. In some instances, end users may post their reviews directly to either the first or second website 105 or 115. In other instances, end users may submit their review to the system 125 and allow the system 125 to categorize their review and post the same to an appropriately themed website. Additional features allow the system 125 to maintain an aggregate score for a third party that includes a median value for all posts received for that particular third party.

Because the system 125 may track posts relative to each third party, the system 125 may track the favorability or negativity rate for each third party as their rates change over time. Therefore, the system 125 may be configured to show third parties with increasingly positive reviews as “trending upwardly.” Contrastingly, the system 125 may be configured to show third parties with decreasingly positive reviews as “trending downwardly.”

In some embodiments, the system 125 may place positive reviews of third parties on the positively themed social media platform and negative reviews for third parties may be input into the negatively themed social media platform. In some instances, the same third party may receive positive and/or negative reviews from end users such that the third party has posts that are on both the positively themed social media platform and the negatively themed social media platform. The system 125 may generate an aggregate review value that includes an average of both positively and negatively worded/themed reviews for a single third party. The system 125 may selectively choose which of the two oppositely themed websites a profile for a third party will be hosted upon based on the average review value calculated for the third party. For example, on a scale of zero to ten, with ten being the most positive, a third party with an average review value of seven may have their profile displayed on the positively themed social network platform. Conversely, a third party with an average review value of three may have their profile displayed on the negatively themed social network platform.

Because the content of these oppositely themed websites is dynamic (e.g., changing over time), the system 125 may mediate the location of the profile of a third party based upon the average review value for the third party. For example, the third party may have an initial average review value of eight. Over a period of time, the average review value for the third party may have an average review value of three, as more negative reviews of the third party are input into the negatively themed social network platform or provided to the system 125. Thus, the profile for the third party may be demoted from the positively themed social media platform (e.g., first website) to the negatively themed social media platform (e.g., second website), and vice-versa.

According to some embodiments, the system 125 may determine a third party with a highest average review value and display the profile of the third party as the most positively reviewed third party. The system 125 may rank the third parties according to their average review value and display the ranking on either of the first and/or second websites. Similarly, the most negatively reviewed third party may be displayed as the “worst offender.” That is, the system 125 may identify the third party on the second website in a conspicuous manner, such as by displaying an image of the third party with a banner that reads “worst offender.”

According to other embodiments, the system 125 may display the profiles of a set number of highly negatively reviewed third parties. End users may be allowed to vote for the third party that they believe is the “worst” third party. In some instances, third parties may be allowed to petition to remove erroneous reviews or profile information.

In some instances, the reviews provided by end users may not be associated with a numeric review value and may include only textual content. Therefore, the system 125 may utilize word recognition to determine a sentiment for the textual content. The system 125 may evaluate individual words or groups of words and assign a sentiment value to the textual content. The system 125 may assign individual words numeric values. For example, the word “terrible” may have a value of two, whereas the word “wonderful” may have a value of seven. The system 125 may agnostically process words such as prepositions or other words having no sentiment, while the system 125 may assign a greater weight to words that are associated with exclamatory statements or punctuation.

In some instances, the system 125 may weight review values input by an end user. For example, even though an end user input a review value of three for a third party, the system 125 may attribute less weight to the review score of the end user because the end user always provides negative reviews. Other types of weighting of reviews that are based on end user bias or other criteria that would be known to one of ordinary skill in the art are likewise contemplated for use in accordance with the present technology.

With regard to the types of content allowed on the oppositely themed websites, end users may be allowed to post textual content, image files, video files, audio files, multimedia files, and so forth. In some instances, end users may take a picture of a third party with their mobile device. The end user may then append the image with a review value and/or a review message. The end user may then upload the post (e.g. image plus review) to the system 125. After determining the review value for the post, the system 125 may upload the post to the appropriately themed website or social network platform. Thus, the system 125 may act as a broker between the end user and the oppositely themed websites.

With regard to brokering, the system 125 may be configured to establish a threshold value that is used to measure third party scores to determine if the third party should be added to the first or second website. When scores for third parties meet or exceed the threshold, the system 125 initially adds the third party to the first website. Conversely, when scores for third parties fall below the threshold, the system 125 initially adds the third party to the second website.

Rather than keeping third parties on the websites in a static manner, the system 125 may monitor the scores for the third parties over time and transfer the third parties between the first and second websites as their scores are compared against the established threshold value. For example, if a score for a third party initially is low enough to cause the system 125 to place the third party on the second website, the system 125 may monitor the score of the third party over time to determine if the end user opinions are changing. If the score for the third party trends high enough, such that it meets or exceeds the threshold, the system 125 may move the third party to the first website.

According to some embodiments, the present technology may utilize facial recognition technologies to identify individuals that may be included in a picture that has been uploaded to the system 125. Thus, the system 125 may maintain a repository of image files for known individuals. The system 125 may compare an uploaded picture to the repository of image files and locate matching image files that are substantially similar to the uploaded picture. End users may vote on whether the selected image files correspond to an individual that is purportedly included in the uploaded picture.

Similarly, the system 125 may utilize speech and/or voice recognition technologies to determine speakers in audio files that are uploaded to the system 125. For example, if an end user receives a harassing voicemail, the end user may upload the voicemail to the system 125 such that the audio signal in the voicemail can be processed to determine a speaker or speakers in the audio signal. The system 125 may maintain a database of voiceprints that correspond to unique individuals. Audio signals can be matched against the database to determine or identify individuals from their voice signatures or voiceprints in the audio signal.

In some embodiments, the system 125 may communicate with the first and second web servers 110 and 120 using a secure or insecure application programming interface (API). An API allows various types of programs to communicate with one another in a language (e.g., code) dependent or language agnostic manner. The system 125 may also receive authentication credentials for the end user (e.g., username and password) that allows the end user to interact with either of the first and second web servers 110 and 120.

The system 125 may also allow for the display, tracking, and/or linking of advertising based content on the oppositely themed social media platforms.

FIG. 2 illustrates an exemplary computing system 200 that may be used to implement an embodiment of the present technology. The computing system 200 of FIG. 2 may be implemented in the contexts of the likes of computing systems, networks, cloud-based computing environments, servers, or combinations thereof disclosed herein. The computing system 200 of FIG. 2 includes one or more processors 210 and main memory 220. Main memory 220 stores, in part, instructions and data for execution by processor 210. Main memory 220 may store the executable code when in operation. The computing system 200 of FIG. 2 further includes a mass storage device 230, portable storage medium drive(s) 240, output devices 250, user input devices 260, a graphics display 270, and peripheral devices 280.

The components shown in FIG. 2 are depicted as being connected via a single bus 290. The components may be connected through one or more data transport means. Processor unit 210 and main memory 220 may be connected via a local microprocessor bus, and the mass storage device 230, peripheral device(s) 280, portable storage device 240, and display system 270 may be connected via one or more input/output (I/O) buses.

Mass storage device 230, which may be implemented with a magnetic disk drive or an optical disk drive, is a non-volatile storage device for storing data and instructions for use by processor unit 210. Mass storage device 230 may store the system software for implementing embodiments of the present technology for purposes of loading that software into main memory 220.

Portable storage device 240 operates in conjunction with a portable non-volatile storage medium, such as a floppy disk, compact disk, digital video disc, or USB storage device, to input and output data and code to and from the computer system 200 of FIG. 2. The system software for implementing embodiments of the present technology may be stored on such a portable medium and input to the computer system 200 via the portable storage device 240.

Input devices 260 provide a portion of a user interface. Input devices 260 may include an alphanumeric keypad, such as a keyboard, for inputting alpha-numeric and other information, or a pointing device, such as a mouse, a trackball, stylus, or cursor direction keys. Additionally, the system 200 as shown in FIG. 2 includes output devices 250. Suitable output devices include speakers, printers, network interfaces, and monitors.

Display system 270 may include a liquid crystal display (LCD) or other suitable display device. Display system 270 receives textual and graphical information, and processes the information for output to the display device.

Peripherals 280 may include any type of computer support device to add additional functionality to the computer system. Peripheral device(s) 280 may include a modem or a router.

The components provided in the computer system 200 of FIG. 2 are those typically found in computer systems that may be suitable for use with embodiments of the present technology and are intended to represent a broad category of such computer components that are well known in the art. Thus, the computer system 200 of FIG. 2 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Macintosh OS, Palm OS, Android, iPhone OS and other suitable operating systems.

It is noteworthy that any hardware platform suitable for performing the processing described herein is suitable for use with the technology. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

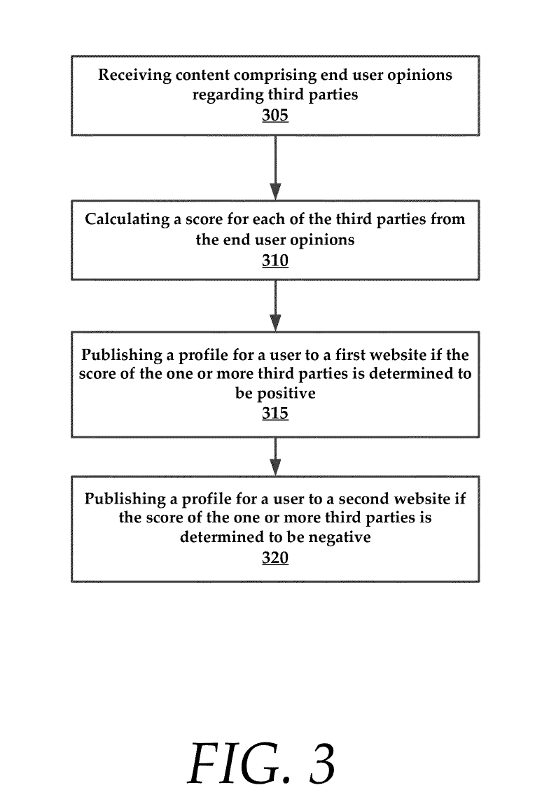

FIG. 3 is a flowchart of an exemplary method for managing content between two or more web servers providing websites that comprise oppositely themed content relative to one another. The method includes receiving 305 content comprising end user opinions regarding third parties. In some embodiments, the method comprises calculating 310 a score for each of the third parties from the end user opinions. It will be understood that the score represents whether the end user opinions are positive or negative.

Next, the method includes publishing 315 a profile for a user to a first website if the score of the one or more third parties is determined to be positive. Alternatively, the method includes publishing 320 a profile for a user to a second website if the score of the one or more third parties is determined to be negative.

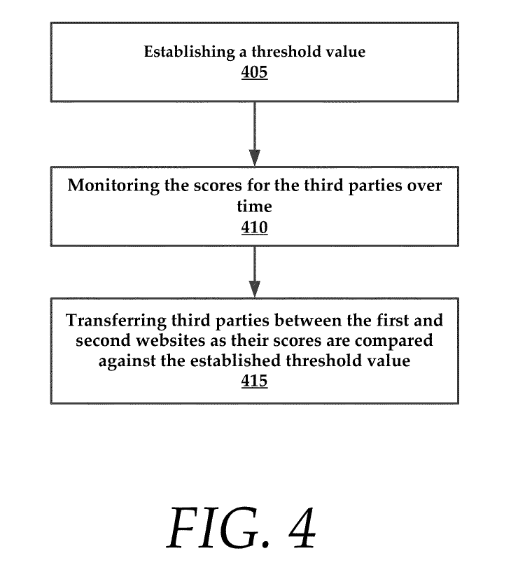

FIG. 4 is a flowchart of a sub-method for continuous monitoring of scores for third parties. The sub-method of FIG. 4 is an exemplary method of calculating a score for a third party (see step 310 of FIG. 3). The method may comprise establishing 405 a threshold value. As mentioned above, the threshold is a benchmark for determining if scores for third parties indicate that the third parties are initially added to the first website or the second website. Scores that meet or exceed the threshold are added to the first website and scores for third parties that fall below the threshold indicate that the third parties are initially added to the second website.

After initial categorization and publishing of third parties to the first or second website, the method includes monitoring 410 the scores for the third parties over time. Also, the method includes transferring 415 third parties between the first and second websites as their scores are compared against the established threshold value. For example, a third party that initially includes a low score may be transferred or “promoted” from the second website to the first website if the system 125 determines that an updated score meets or exceeds the threshold established.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for managing content between two or more web servers providing websites that comprise oppositely themed content relative to one another, the method comprising:
receiving content comprising end user opinions regarding third parties;
calculating a score for each of the third parties from the end user opinions, the score representing whether the end user opinions are positive or negative;
publishing a profile for a user to a first website if the score of the one or more third parties is determined to be positive; and
publishing a profile for a user to a second website if the score of the one or more third parties is determined to be negative.

2. The method according to claim 1, wherein the score is an aggregate score of all end user opinions for a third party.

3. The method according to claim 1, further comprising:
establishing threshold value, where scores for third parties that meet or exceed the threshold indicate that the third parties are initially added to the first website and where scores for third parties that fall below the threshold indicate that the third parties are initially added to the second website;
monitoring the scores for the third parties over time; and
transferring third parties between the first and second websites as their scores are compared against the established threshold value.

4. The method according to claim 1, wherein calculating a score comprises conducting a keyword analysis of the end user opinions, wherein each word or phrase is assigned a numerical value.

5. The method according to claim 4, wherein calculating a score further comprises determining a sentiment score for each of the end user opinions.

6. The method according to claim 1, further comprising determining a third party with a lowest score; and identifying the third party on the second website in a conspicuous manner.

7. A content management system, comprising:
a memory for storing executable instructions; and
a processor for executing the executable instructions to perform operations comprising:
receiving content comprising end user opinions regarding third parties;
calculating a score for each of the third parties from the end user opinions, the score representing whether the end user opinions are positive or negative;
publishing a profile for a user to a first website if the score of the one or more third parties is determined to be positive; and
publishing a profile for a user to a second website if the score of the one or more third parties is determined to be negative.

8. The system according to claim 7, wherein the score is an aggregate score of all end user opinions for a third party.

9. The system according to claim 7, wherein the processor executes the instructions to perform operations comprising:
establishing threshold value, where scores for third parties that meet or exceed the threshold indicate that the third parties are initially added to the first website and where scores for third parties that fall below the threshold indicate that the third parties are initially added to the second website;
monitoring the scores for the third parties over time; and
transferring third parties between the first and second websites as their scores are compared against the established threshold value.

10. The system according to claim 7, wherein calculating a score comprises conducting a keyword analysis of the end user opinions, wherein each word or phrase is assigned a numerical value.

11. The system according to claim 10, wherein calculating a score further comprises determining a sentiment score for each of the end user opinions.

12. The system according to claim 7, wherein the processor executes the instructions to perform operations comprising determining a third party with a lowest score; and identifying the third party on the second website in a conspicuous manner.
